(19) United States
(12) Patent Application Publication
(10) Pub. No.: US 2026/0067180 A1
(43) Pub. Date: Mar. 5, 2026

(54) SCALABLE DATA INFRASTRUCTURE FOR A DATA PLATFORM

(71) Applicant: DISH Wireless L.L.C., Englewood, CO (US)

(72) Inventors: Madhuri Muttreja, Parker, CO (US); Darshit Gandhi, Englewood, CO (US)

(21) Appl. No.: 18/823,132

(22) Filed: Sep. 3, 2024

(51) Int. Cl. H04L 41/40; H04L 41/0894; H04L 41/22

(52) U.S. Cl. CPC H04L 41/40; H04L 41/0894; H04L 41/22

(57) ABSTRACT

This disclosure relates to generating executable code using a data platform. One method includes presenting a graphical user interface (GUI) of a data platform associated with a software-defined network (SDN). The GUI includes a canvas, a toolbox area with one or more graphical objects each representing executable code to perform one or more functions in the SDN, and a policy area with one or more graphical objects each representing a set of one or more policy rules for governing how data is at least one of handled, stored, accessed, or protected. The method receives user input that causes graphical objects in the toolbox area and the policy area to move to the canvas. The method receives third user input that causes the data platform to generate output executable code based on the graphical objects in the canvas. The method outputs the output executable code.

### BACKGROUND

Telecommunication networks, such as cellular networks, have various resources that produce data and metadata concerning operations of the cellular network. Metadata is data that provides information about data. Metadata enriches the data with information about one or more aspects of the data. Metadata insights can facilitate efficient processing and understanding the data. Status reports, including error codes, may be generated which are indicative of deficiencies in operations of the network. With the development of information technology, data to be used in different applications can be large in volume and complex in variety. The data can include a great quantity of diverse information from various data sources/data owners. With the development of communication technologies, such as fifth generation (5G) new radio (NR) cellular networks, applications supporting a massive number of connected devices are enabled. Such applications can be based on data from myriad sources, including third party sources. Obtaining insight of the data can be important to create and capture value from the data, for example, to develop data products.

The 5G NR cellular networks being cloud-native architectures has created a very vast opportunity to use the data from the network to create service-level agreement (SLA) driven network of networks, private networks, etc. There are opportunities to bring the value from data that is generated by the 5G NR cellular network, given that the cellular network can be an open, secure, flexible, cloud-native network. 5G NR cellular networks now have the capability to build intelligence at every cell tower, at various network tiers from National Data Center, Regional Data Center, Edge Data centers including the Cell Sites. All the components that are software driven can use this opportunity. However with this opportunity, telecommunication companies will have enormous amounts of data at hand that can lead to automation, orchestration with infinite intelligence driven from the network. This can be monetized with enterprise customers. The problem is that every node of the network needs to be a self-perfecting node. This is a huge challenge knowing the spread of the network nodes across tiers, cloud-computing regions, and cell-sites. To enable the data-scientists and data engineers, the data needs to be easily accessible, visible securely and of good quality. Data quality is the measure of how well suited a data set is to serve its specific purpose. Data that is deemed fit to serve the specific purpose in a particular context is considered high quality data. Low quality data can be of low value and lead to poor decision making.

A developer needs availability, visibility, tools, and data quality for developing utilities, applications, solutions, pipelines, etc., for the cellular network. As cellular networks scale, the data management at scale becomes challenging. For example, the applications in the 5G network require fast data processing and low latency to enable real-time communications. The data of the applications can include unstructured data, which makes it difficult for application developers to parse, analyze and use the data efficiently.

Developers are often tasked to solve specific problems by developing specific utilities, applications, solutions, pipelines, etc. There are no mechanisms to share and re-use already developed code with other developers that are often solving similar problems, but maybe in a different context. This leads to inefficient use of developer resources.

### BRIEF DESCRIPTION OF DRAWINGS

The present disclosure is illustrated by way of example, and not by way of limitation, in the figures of the accompanying drawings.

FIG. 1 is a block diagram of a system implementing a data platform in a cellular network according to at least one embodiment.

FIG. 2 illustrates a graphical user interface (GUI) of a data platform associated with a software-defined network (SDN), the GUI including a canvas, a toolbox area, and a policy area according to at least one embodiment.

FIG. 3 the GUI of FIG. 2 with an example engineering solution in the canvas according to at least one embodiment.

FIG. 4 is a block diagram depicting a network infrastructure component on which at least a portion of the data platform may operation, according to at least one embodiment.

FIG. 5 is a flow chart of a method of generating output executable code based on graphical objects in a canvas of a GUI presented by a data platform according to at least one embodiment.

FIG. 6 is a block diagram of an example environment for providing a data platform with a GUI for creating or modifying graphical objects representing underlying executable code for functions of a cellular network according to at least one embodiment.

FIG. 7 is a block diagram of an example procedure for assessing and improving the data quality of unstructured data.

FIG. 8 is an example of the graph database representing metadata of data files.

FIG. 9 is a flow diagram of an example process for assessing and improving the data quality of unstructured data.

### DETAILED DESCRIPTION

As discussed above, as communication technologies advance, including the emergence of fifth generation (5G) new radio (NR) cellular networks, the data needs to be easily accessible, visible securely and of good quality for a developer to develop utilities, applications, solutions, pipelines, etc., for the data of the cellular network. As cellular networks scale, the data management at scale becomes challenging. Developers are often tasked to solve specific problems by developing specific utilities, applications, solutions, pipelines, etc. There are no mechanisms to share and re-use already developed code with other developers that are often solving similar problems, but maybe in a different context. This leads to inefficient use of developer resources. And this data problem exploded due to the scale of being distributed not just with physical data sources but with experts from domain expertise of the network. It would be extremely difficult for a central hyper-specialized team to be able to understand the nuances of the domain knowing that it takes thousands of attributes to configure the components and hundreds of metrics and counters to monitor the components.

Aspects and embodiments of the present disclosure overcome these deficiencies and others by a data platform with a scalable data infrastructure. The data platform can provide a solution to create once and use many times for all solutions. The data platform can be self-service to enable all engineers and scientists within governance to innovate and be creative to bring value from the network data that is now available for wider use cases. The data platform can provide business domain users autonomy to establish rules and solutions specific to their domains. The data platform can enable sharing everything so teams are not building in a compartmentalized fashion (i.e., building in silos) and collaborating for speed and case to start for the domain engineers without much steep learning curve. The data platform allows telecommunication experts, who are not necessarily data experts and have diverse domain knowledge, to easily develop rules and solutions specific to their domains.

Aspects and embodiments of the data platform can include a framework with three primary sections to expand on capabilities and features: 1) Toolbox; 2) Policy; and 3) Canvas. The toolbox section provides that any solution that is engineered will be cataloged for everyone to be able to consume, enhance and improve on and check back in for further sharing. This is to help avoid redundancy in building solutions causing extensive management for operations teams. The policy section can provide the applications that will help the business domain engineers and subject matter experts (SMEs) to establish rules on the data, like naming conventions, quality, and security governance policies, etc. The canvas section is for data-scientists and data engineers to pull in various solutions and/or policy in a plug-and-play mode for building solutions and innovating. Aspects and embodiments of the data platform can enable buildout of artificial intelligence, such as generative AI (Gen AI), machine learning (ML), and other processing solutions, at scale for each and every one who has an innovative idea that they need.

Aspects and embodiments of the data platform can provide an efficient and automatic way generate utilities, applications, solutions, pipelines, etc., to identify data from various sources, process large scale data, assess data quality of the data based on a set of rules, identify, and improve data with low quality (not satisfying one or more rules).

It is appreciated that methods and systems in accordance with the present disclosure can include any combination of the aspects and features described herein. That is, methods and systems in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

Other embodiments of this aspect include corresponding computer systems, apparatus, computer program products, and computer programs recorded on one or more computer storage devices, each configured to perform the actions of the method. A system of one or more computers can be configured to perform particular operations or actions by virtue of having software, firmware, hardware, or a combination of them installed on the system that in operation causes or causes the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations, the method can include presenting, by a computing system, a GUI of a data platform associated with a SDN, the GUI includes a canvas, a toolbox area includes one or more graphical objects each representing executable code to perform one or more functions in the SDN, and a policy area includes one or more graphical objects each representing a set of one or more policy rules for governing how data is at least one of handled, stored, accessed, or protected by the one or more functions in the SDN. The executable code can be a set of one or more instructions that are executed by the computing system. In some implementations, the method can include receiving, by the computing system, first user input that causes a first graphical object in the toolbox area to move to the canvas, where the first graphical object represents first executable code (i.e., a first set of instructions) to perform a first set of one or more functions; receiving, by the computing system, second user input that causes a second graphical object in the policy area to move to the canvas, where the second graphical object represents a first set of one or more policy rules for governing how data is at least one of handled, stored, accessed, or protected by executable code represented by graphical objects moved to the canvas; receiving, by the computing system, third user input that causes the data platform to generate output executable code based on the graphical objects in the canvas, and outputting the output executable code.

In some implementations, the first executable code is or defines at least one of a utility program, an application, a function, a routine, a script, a processing pipeline, or a solution includes a plurality of interconnected blocks, each includes at least one of a utility program, an application, a function, a routine, a script, or a processing pipeline. In some implementations, the first set of one or more policy rules includes at least one of a data policy rule, a privacy policy rule, a quality policy rule, a retention policy rule, a security policy rule, a naming convention policy rule, a context data policy rule, or an access-model policy rule.

In some implementations, the method can include, prior to receiving the third user input: receiving fourth user input that causes a third graphical object in the toolbox area to move to the canvas, where the third graphical object represents second executable code (i.e., a second set of instructions) to perform a second set of one or more functions; and receiving fifth user input that generates an interface between the first executable code of the first graphical object and the second executable code of the third graphical object, where the output executable code includes at least the first executable code, the second executable code, and the interface between the first executable code and the second executable code. In some implementations, the first graphical object is a first solution includes a first plurality of interconnected blocks, each includes at least one of a utility program, an application, a function, a routine, a script, or a processing pipeline, and the second graphical object is a second solution includes a second plurality of interconnected blocks, each includes at least one of a utility program, an application, a function, a routine, a script, or a processing pipeline. In some implementations, the first graphical object is a first solution includes a first plurality of interconnected blocks, each includes at least one of a utility program, an application, a function, a routine, a script, or a processing pipeline, and the second graphical object is a processing pipeline.

In some implementations, the method can include receiving, by the computing system, fourth user input that modifies at least one of the first executable code of the first graphical object or the first set of one or more policy rules of the second graphical object; and receiving, by the computing system, fifth user input that creates a fourth graphical object in the toolbox area or the policy area, the fourth graphical object includes the at least one of the modified first executable code or the modified first set of one or more policy rules.

In some implementations, the computing system is a cloud computing system, and the data platform is implemented in the cloud computing system.

Particular implementations of the subject matter described in this disclosure can be implemented so as to realize one or more of the following advantages. By providing the data platform, and the underlying framework of the toolbox area, policy area, and canvas, the technologies described herein can enhance efficiency of data processing, reduce latency and cost of data analysis, and improve data accuracy and consistency for applications, which can lead to informed decision making and improved user experience. Aspects and embodiments of the present disclosure can provide a framework that is built to operate in a cohesive and coherent manner to manage the scale of distributed data, the spread of developers, and the sprawl of data engineering across the hyper distributed ecosystem of data in a cellular network. The key characteristics of the framework includes: i) create once use many times, ii) self-service, iii) automation of deployments, iv) time to market for developers, v) in-built declarative governance, vi) reduced redundancy of data-solutions, vii) minimal data duplication to support the innovation required for the telecommunications AI/ML and generative AI (GenAi). The main need of the AI/ML, Gen AI at scale is the management of all of these characteristics of the framework.

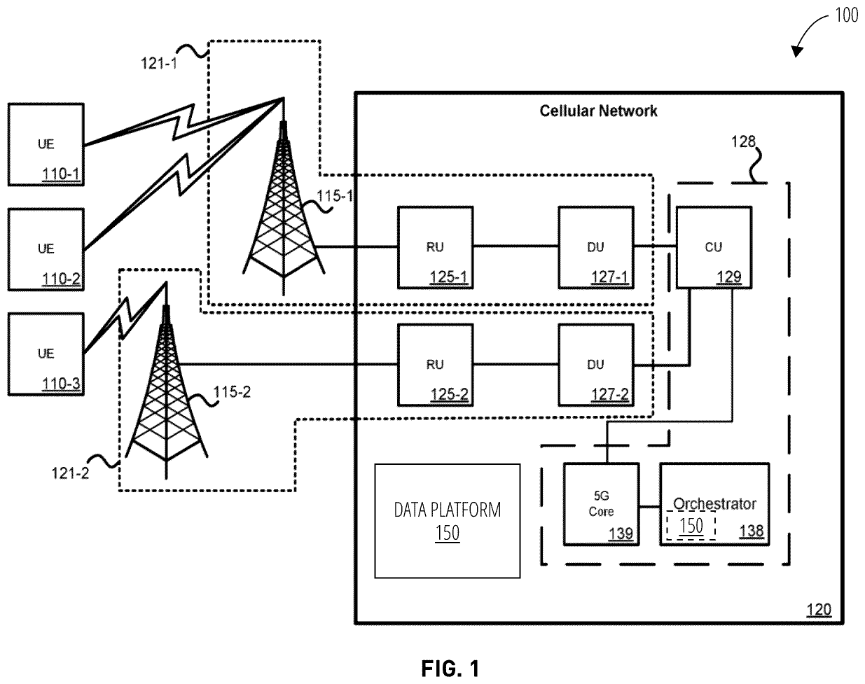

FIG. 1 is a block diagram of a cellular network system 100 (“system 100”) implementing a data platform 150 in a cellular network according to at least one embodiment. FIG. 1 represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station structure 115; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations and many CUs and 5G core 139. Structure 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection- and session-related information from UE and is responsible for handling connection and mobility management tasks. SMF is responsible for interacting with the decoupled data plane, creating, updating, and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

As illustrated in FIG. 1, the system 100 includes a data platform 150. The data platform 150 is a system or suite of tools and technologies designed to manage, store, process, analyze, and/or visualize large volumes of data. The data platform 150 can be used by modern data-driven organizations, enabling them to harness the power of their data for various purposes, such as business intelligence, analytics, machine learning, and more. In general, the data platform 150 includes components for data ingestion, data storage, data processing, data management, data integration, data analytics, machine learning (ML) and artificial intelligence (AI) platforms, data security, or the like. For example, a data ingestion component can use extract, transform, load (ETL) logic (tools or processes) that extract data from various sources, transform it into a suitable format, and load it into a storage system. The data ingestion component can be set up to stream real-time data from sources, such as Internet of Things (IoT) devices, transactional systems, or other network functions. The data platform 150 can include data storage components, such as data lakes, data warehouses, database systems. Data lakes are large storage repositories that hold raw data in its native format until it is needed. Data warehouses is structured storage systems optimized for query performance and analytics, often storing cleaned and processed data. Database Systems can include both relational (e.g., SQL) and non-relational (e.g., NoSQL) databases for various data storage needs. The data processing components can handle batch processing, streaming processing, or the like. Batch processing can handle large volumes of data in batches, typically for tasks like reporting, data transformation, and aggregation. Stream processing can handle real-time processing of continuous data streams to support applications like real-time analytics and monitoring. Data management components can handle metadata management and data governance. The metadata management can include tools for managing metadata, which is data about data, including data catalogs, lineage, and governance. Data Governance can include policies and processes to ensure data quality, security, privacy, and compliance with regulations. Data integration components can provide application programming interfaces (APIs), data virtualization, etc. The APIs can be used for accessing and integrating data across different systems. Data Virtualization techniques can be used for abstracting and integrating data from various sources without moving it physically. The data analytics components can have Business Intelligence (BI) and advanced analytics tools and platforms for data reporting, visualization, and dashboards to support decision-making. Advanced analytics techniques, like data mining, predictive analytics, and statistical analysis, can be used to derive deeper insights. The ML/AI platforms can provide a model training platform for developing and training machine learning models using data stored in the platform, and a model deployment platform for deploying trained models into production environments for real-time or batch inference. Data security components can provide access control, encryption, etc. Access control mechanisms can be used for ensuring that only authorized users can access specific data. Encryption techniques can be used for protecting data both at rest and in transit to prevent unauthorized access and breaches. The data platform 150 can consolidate data from various sources into a single platform, making it easier to manage and access. The data platform 150 can supports large-scale data storage and processing, accommodating growing data volumes and increasing complexity. The data platform 150 can enable real-time data processing and analytics, allowing organizations to respond quickly to changing conditions. The data platform 150 can facilitate collaboration across different departments and teams by providing a unified data environment. The data platform 150 can implement data governance and quality control measures to ensure the accuracy and reliability of data. The data platform 150 can provide organizations with the tools and insights needed to make informed, data-driven decisions. In summary, the data platform 150 can provide the infrastructure and tools needed to manage, process, and analyze data effectively, enabling organizations to unlock the full potential of their data assets. The data platform 150 can also provide business intelligence and reporting. The data platform 150 can aggregate data from multiple sources to generate comprehensive reports and dashboards for business analysis. The data platform 150 can provide real-time analytics. In particular, the data platform 150 can monitor and analyze data streams in real-time to gain immediate insights and drive instant actions. The data platform 150 can provide customer insights by analyzing customer data to understand behavior patterns, preferences, and trends to improve customer experience and loyalty. The data platform 150 can implement predictive maintenance as well, such as using machine learning models to predict equipment failures and schedule proactive maintenance in industries like manufacturing and utilities.

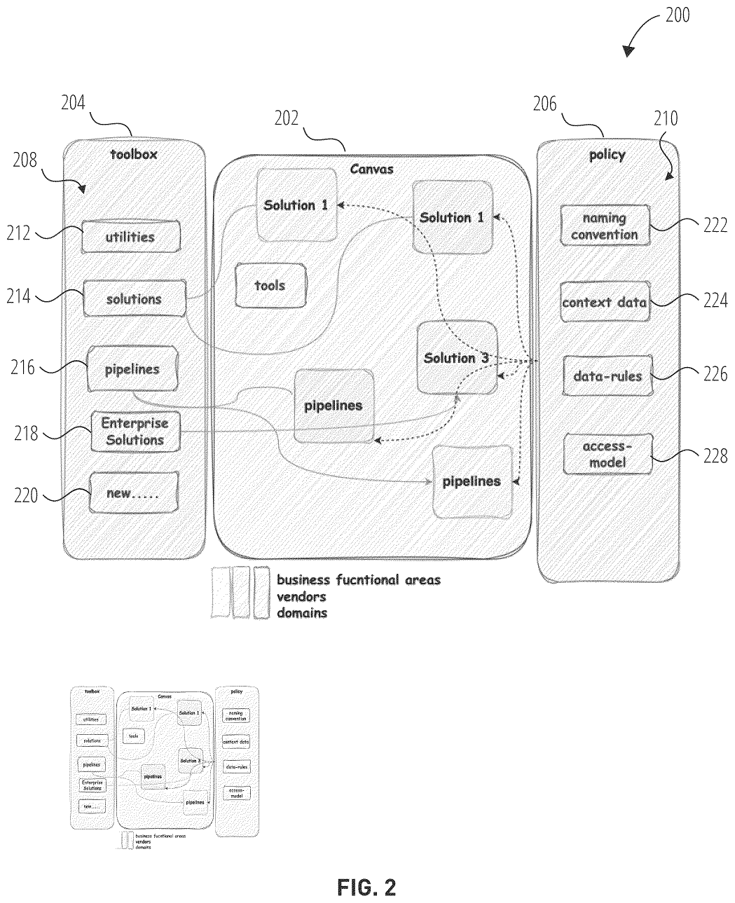

As described herein, the data platform 150 can be implemented in a cloud computing system, providing data storage, data warehousing, real-time data processing, analytic engines for large-scale data processing, ML/AI services, data flow for stream and batch processing, or other data services. As described in more detail below, the data platform 150 can provide and present a GUI with a framework with three main sections: a canvas, a toolbox area, and a policy area for generating and/or modifying executable code (represented by graphical objects in the GUI) for utility programs, applications, functions, routines, scripts, processing pipelines, solutions, connector functions, object stores, enterprise integration tools, or other executable code. An example GUI is illustrated and described below with respect to FIG. 2.

FIG. 2 illustrates a graphical user interface (GUI) 200 of a data platform associated with a software-defined network (SDN), the GUI 200 including a canvas 202, a toolbox area 204, and a policy area 206 according to at least one embodiment. The toolbox area 204 includes one or more graphical objects 208 each representing executable code to perform one or more functions in the SDN. The policy area 206 includes one or more graphical objects 210 each representing a set of one or more policy rules for governing how data is at least one of handled, stored, accessed, or protected by the one or more functions in the SDN.

As described above, the data platform 150 can provide the GUI 200 for creating, modifying, re-using, improving executable code for an SDN, such as for a cellular network (e.g., fifth generation (5G) new radio (NR) cellular network, sixth generation (6G) cellular networks, etc.). The framework of the data platform 150 includes three main sections, as reflected in the GUI 200. In particular, the GUI 200 includes the canvas 202, toolbox area 204, and policy area 206. The canvas 202 can be an area within the GUI 200 where graphical objects 208 and graphical objects 210 can be manipulated for developers of executable code within the data platform 150. The canvas 202 can include a surface area on the display where shapes, text, images, and other graphical elements can be rendered. The canvas 202 can support both two-dimensional (2D) and three-dimensional (3D) graphics. For instance, an HTML5 canvas is often used for 2D rendering, while WebGL can be used for 3D rendering on the canvas 202. The canvas 202 can have a set of APIs that allow developers to draw and manipulate graphics programmatically. For example, the HTML5 canvas element has a 2D rendering context API that provides methods and properties for drawing and manipulating graphics. The canvas 202 can support event handling for user interactions, such as mouse clicks, drags, and keyboard inputs, which is essential for creating interactive activity of the graphical objects. The canvas 202 can help developers to create, modify, re-use, improve executable code by manipulating graphical objects 208 and graphical objects 210 from the toolbox area 204 and the policy area 206 within the canvas 202. In addition to manipulating graphical objects 208 and graphical objects 210 into the canvas 202, the developer can modify the underlying code of these objects, either creating a new instance or modifying an existing instance. The developer can create connections between these graphical objects as well, the connections representing interfaces, data flows, or the like between the underlying executable code of these graphical objects.

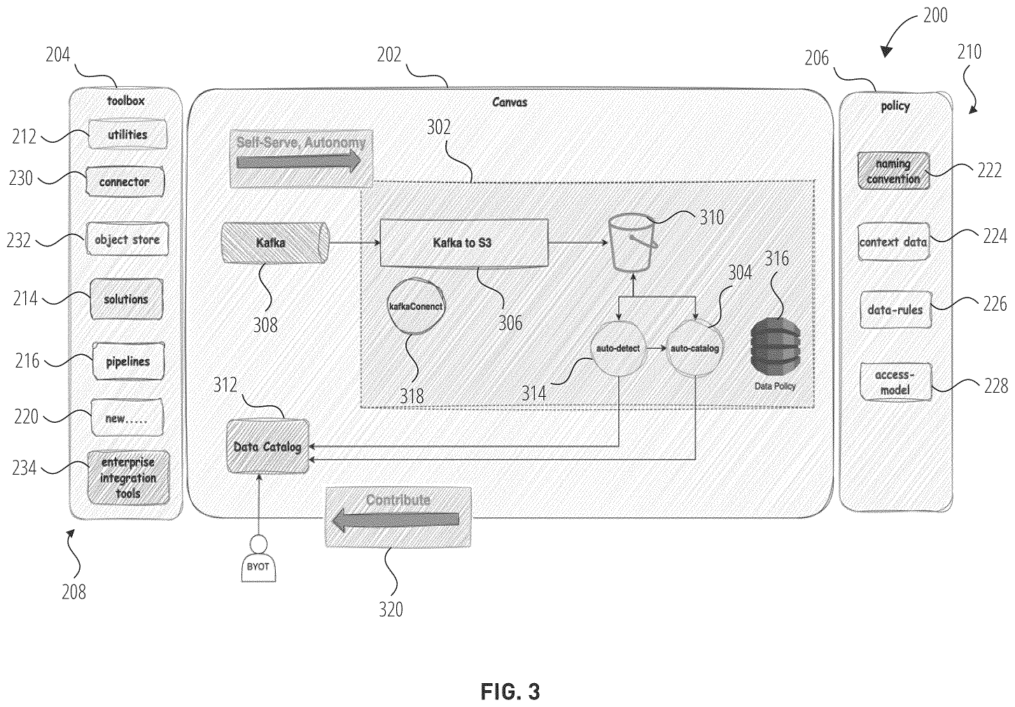

The executable code of the graphical objects 208 can include one or more utility programs 212, one or more applications, a function (e.g., network function), a routine, a script, a processing pipeline 216, a solution 214, connector functions 230 (illustrated in FIG. 3), object store 232 (illustrated in FIG. 3), enterprise integration tools 134 (illustrated in FIG. 3), or other executable code 220. The solution 214 can include a set of interconnected blocks, each block representing a utility program, an application, a function, a routine, a script, or a processing pipeline.

A utility (often referred to as a utility program or utility software) is a type of system software designed to help analyze, configure, optimize, or maintain a computer system. Utilities are often simple, single-purpose programs that perform a specific function or set of functions, such as system optimization, file management, system analysis, security, maintenance, data recovery, networking, system configuration, etc. Some examples of utilities in the cellular network environment include data quality conventions enforcements, data format changing, splitting data sets into readable formats, encrypting data, etc. Utilities can help in improving the performance of the network resource. Utilities can streamline system operations, manage files and directories, provide file compression, facilitate data transfers, provide information about the system's performance, resource usage, and hardware status. The utilities can include task managers, system monitors, diagnostic tools, configuration editors, control panels, and the like. Utilities can be used for security and maintenance, data recovery, networking, and software or hardware configuration.

A processing pipeline 216 can be a series of data processing stages where the output of one stage is the input to the next. The processing pipeline 216 can include sequential processing, parallel processing, or a combination of both. The processing pipeline 216 can provide modularity, allowing individual stages to be developed, tested, and maintained independently. The processing pipeline 216 can manage the flow of data through the system, ensuring that each stage receives data at the right time and in the correct format. The processing pipeline 216 can include mechanisms for handling errors and exceptions at various stages, ensuring robustness and reliability. The processing pipeline 216 can be used for executing instructions. For example, an instruction pipeline can allow multiple instruction phases (fetch, decode, execute, etc.) to overlap, improving overall instruction throughput. ETL pipelines can be used in data engineering to extract data from various sources, transform it into a suitable format, and load it into a data warehouse or database. Continuous Integration/Continuous Deployment (CI/CD) pipelines can automate the process of code integration, testing, and deployment, ensuring rapid and reliable software delivery. ML pipelines can automate the workflow of data preprocessing, model training, validation, and deployment, facilitating the development of machine learning models.

In at least one embodiment, the processing pipeline 216 includes a data processing pipeline, with one or more of the following stages: data ingestion; data cleansing, data transformation, data storage, and data analysis. In the data ingestion stage, data is collected from various sources, such as databases, APIs, or file systems. In the data cleansing stage, raw data is cleaned and transformed to remove errors, duplicates, and inconsistencies. In the data transformation stage, cleaned data is transformed into the required format or structure for analysis. In the data storage stage, transformed data is loaded into a data warehouse, database, or data lake for storage and future analysis. In the data analysis stage, stored data is analyzed using various tools and techniques to extract insights and generate reports.

In at least one embodiment, the toolbox area 204 includes a processing pipeline 216 that has been previously developed and stored in the data platform 150 by another developer. A current developer can re-use the processing pipeline 216 by dragging the graphical object of the processing pipeline 216 into the canvas 202. The current developer could modify the corresponding code of the processing pipeline 216 to obtain a new processing pipeline and stored back to the data platform 150, as well as presented as a new graphical object or a modified graphical object in the toolbox area 204.

As illustrated in FIG. 2, the canvas 202 includes multiple graphical objects 208 and graphical objects 210 as an example. In this example, a developer has manipulated various graphical objects 208 into the canvas 202, such as a first solution for a business functional area, a first solution for a vendor, a third solution for a domain, tools, and a processing pipeline for the business functional area and a processing pipeline for the vendor. In other examples, different graphical objects 208 can be selected by being manipulated to the canvas 202. In some cases, connectors can be created between graphical objects in the canvas 202. The connectors can suggest flow of data between different underlying executable code of the graphical objects. In some cases, the graphical objects do not need to be connected to other graphical objects.

The graphical objects 210 represents a set of one or more policy rules for governing how data is at least one of handled, stored, accessed, or protected by executable code represented by the graphical objects 210 moved into the canvas 202. The policies of the graphical objects 210 can include a naming convention policy rule 222, a context data policy rule 224, a data policy rules 226, access-model policy rule 228, or other policy rules, such as a privacy policy rule, a quality policy rule, a retention policy rule, a security policy rule, a data access policy rule, or the like.

During operation of the GUI 200, a computing system presenting the GUI 200 can receive first user input that causes a first graphical object in the toolbox area 204 to move to the canvas 202. The first graphical object represents first executable code to perform a first set of one or more functions. The computing system can receive second user input that causes a second graphical object in the policy area 206 to move to the canvas 202. The second graphical object represents a first set of one or more policy rules for governing how data is at least one of handled, stored, accessed, or protected when moved to the canvas 202. Upon completion of manipulations of the graphical objects 208 and graphical objects 210, the computing system can receive third user input that causes the data platform 150 to generate output executable code based on the graphical objects in the canvas 202. The computing system can output the executable code. For example, the executable code can be downloaded by the developer, deployed by the developer to a location in the network, etc.

In another embodiments, prior to receiving the third user input, the computing system receives fourth user input that causes a third graphical object in the toolbox area to move to the canvas, where the third graphical object represents second executable code to perform a second set of one or more functions. The computing system receives fifth user input that generates an interface between the first executable code of the first graphical object and the second executable code of the third graphical object, where the output executable code comprises at least the first executable code, the second executable code, and the interface between the first executable code and the second executable code. In at least one embodiment, the first graphical object is a first solution having a first plurality of interconnected blocks, each comprising at least one of a utility program, an application, a function, a routine, a script, or a processing pipeline. The second graphical object is a second solution having a second plurality of interconnected blocks, each comprising at least one of a utility program, an application, a function, a routine, a script, or a processing pipeline.

In at least one embodiment, the first graphical object is a first solution having a first plurality of interconnected blocks, each comprising at least one of a utility program, an application, a function, a routine, a script, or a processing pipeline. The second graphical object is a processing pipeline. Alternatively, other combination of executable code can be combined, modified, reused by manipulations of the graphical objects 208 in the canvas 202.

In at least one embodiment, the computing system receives fourth user input that modifies at least one of the first executable code of the first graphical object or the first set of one or more policy rules of the second graphical object. The computing system receives fifth user input that creates a fourth graphical object in the toolbox area or the policy area, the fourth graphical object comprising the at least one of the modified first executable code or the modified first set of one or more policy rules.

FIG. 3 the GUI 200 of FIG. 2 with an example engineering solution in the canvas 202 according to at least one embodiment. In this example, a develop can be given a requirement to be able to ingest data from an event streaming platform (e.g., Apache Kafka bus) into a cloud-based storage unit (e.g., Amazon Web Services (AWS) Simple Storage Service (S3) bucket), and track the data at both source and destination. Kafka is an open-source distributed event streaming platform developed by the Apache Software Foundation. It is designed for high-throughput, low-latency data streaming and is used to build real-time data pipelines and streaming applications. Kafka is capable of handling trillions of events per day and supports features such as message publishing and subscribing, fault tolerance, scalability, and distributed storage. It can be used for log aggregation, real-time analytics, and event sourcing. The S3 bucket is a fundamental storage unit that is used to store and manage data objects, which can include files, images, videos, and backups. Each bucket is uniquely identified by a key and can hold an unlimited amount of data. Features of S3 buckets include versioning, access controls, lifecycle policies for data archiving, and replication for data durability and availability.

During operation of the data platform, the data platform can present the GUI 200 to allow the develop to create and/or modify a solution for a particular domain. The developer can select a pre-engineered solution 302 from the toolbox area 204 and drag the corresponding graphical object 208 into the canvas 202. The pre-engineered solution 302 includes an ingestion function 306 that can be connected to a Kafka bus 308. The ingestion function 306 can use a connection utility, such as Kafka connect function 318. The ingestion function 306 can ingest data from the Kafka bus 308 and store the ingested data in a storage container 310 (e.g., S3 bucket). The pre-engineered solution 302 can also include a catalog function 304 (labeled “auto-catalog”) that automatically catalogs the data in the storage container 310 into a data catalog 312. The pre-engineered solution 302 can also include a detection function 314 (labeled “auto-detect”) to automatically detect changes to the data in the storage container 310 to reflect in the data catalog 312. The developer can bring in the pre-engineered solution 302, the Kafka bus 308, and data catalog 312 into the canvas 202 and create the corresponding connections between these functions. Similarly, the developer can interact with the objects in the canvas 202, such as to make modifications to the functions. For example, the developer can decide that a certain set of one or more data policy rules 316 should be applied to the pre-engineered solution 302. That is, the developer can drag one or more graphical objects 210 from the policy area 206 into the pre-engineered solution 302.

In some cases, the developer can use the pre-engineered solution 302 as-is. In other cases, the developer can modify aspects of the pre-engineered solution 302, such as including additional utilities, programs, functions, pipelines, or the like within the pre-engineered solution 302, essentially creating a new solution. The modified solution can be saved back to the toolbox area 204 to either overwrite the existing pre-engineered solution 302 or create another object in the toolbox area 204. For example, the GUI 200 can include a contribute widget 320, which when activated, cause the current design in the canvas 202 to be saved back to the toolbox area 204, either as a new graphical object or a modified version of an existing graphical object. It should be noted that the graphical objects themselves may not necessary be modified (e.g., except a visual label of the graphical object), but the underlying executable code is modified according to the modifications being made in the canvas 202. The canvas 202 allows a simple plug-and-play approach to providing a fast head start to create a solution from someone from a business domain that does not necessarily have the data-engineering background. The canvas 202 allows developers to create once and allow the graphical objects 210 to be used by many.

It should be noted that a computing system receives user inputs via the GUI 200 to manipulate the graphical objects in the GUI 200 to perform the various operations. For example, the computing system receives user input when the developer activates the contribute widget 320. The computing system performs the necessary operations to save the current solution on the canvas 202 to the toolbox area 204 for future use. The GUI 200 can provide additional prompts to the developer, such as whether it should create a new solution object in the toolbox area 204. Similarly, when the developer moves one of the graphical objects 210 into the canvas 202 (or within one of the graphical objects in the canvas 202, the computing system can receive user input that causes the underlying executable code associated with the graphical objects 210 to be applied to the pre-engineered solution 302. The data policy rules can be added to the data at all places as needed and defined by the SMEs. The data policies can be distributed across the ecosystem, preventing bad data (i.e., lower quality data) from being propagated all over the data platform. It can be important for generative AI to stop sprawling of low-quality data and get the data in a structured, guaranteed way.

Using the GUI 200, the developer can create or modify utilities, applications, solutions, pipelines, etc., for the cellular network with visibility and data quality. The GUI 200 can also provide availability, visibility, tools, and data quality for developing the utilities, applications, solutions, pipelines, etc., for the cellular network.

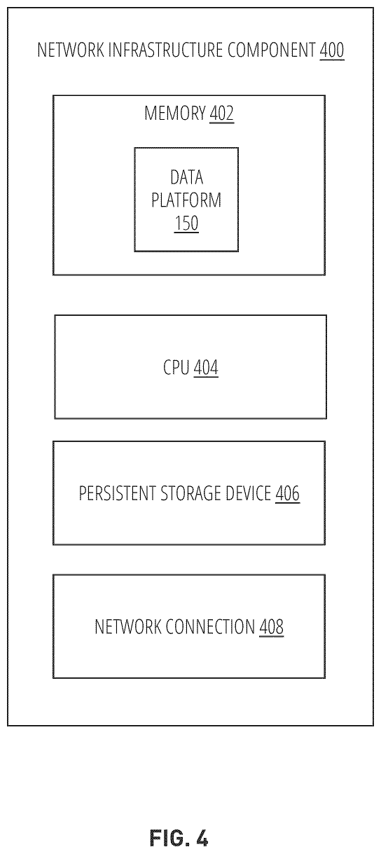

FIG. 4 is a block diagram depicting a network infrastructure component 400 on which at least a portion of the data platform may operation, according to at least one embodiment. The network infrastructure component 400 may be: located on a network in a position to communicate with other network infrastructure components and user device, in order to perform at least part of the functions required in managing a mobile network. A plurality of network infrastructure components may each implement a portion of the distributed data mesh system, thus distributing the system across a plurality of network infrastructure components. In various embodiments, the network infrastructure component 400 includes one or more of the following: a computer memory 402, a central processing unit (CPU) 404, a persistent storage device 406, and a network connection 408. The memory 402 may be used for storing programs and data while they are being used, including data associated with the various network infrastructure components, an operating system including a kernel (not shown), and device drivers (not shown). The CPU 404 may be used for executing computer programs (not shown). The persistent storage device 406 may be a hard drive or flash drive for persistently storing programs and data. The network connection 408 may be used for connecting to one or more network infrastructure components or other computer systems (not shown), to send or receive data, such as via the Internet or another network and associated networking hardware, such as switches, routers, repeaters, electrical cables and optical fibers, light emitters and receivers, radio transmitters and receivers, and the like, and to scan for and retrieve signals from network infrastructure components, or other network functions, and for connecting to one or more computer devices such as network infrastructure components or other computer systems. In various embodiments, the network infrastructure component 400 additionally includes input and output devices, such as a keyboard, a mouse, display devices, etc.

While a network infrastructure component 400 configured as described may be used in some embodiments, in various other embodiments, the network infrastructure component 400 may be implemented using devices of various types and configurations, and having various components. The memory 402 may include the data platform 150 which contains computer-executable instructions that, when executed by the CPU 404, cause the network infrastructure component 400 to perform the operations and functions described herein. For example, the programs referenced above, which may be stored in computer memory 402, may include or be comprised of such computer executable instructions. The memory 402 may also include a network infrastructure component data structure.

The data platform 150 performs the core functions of the network infrastructure component 400, as discussed herein. In particular, the data platform 150 facilitates the management of creating, modifying, saving, and deploying executable code for collecting, processing, and storing data of a cellular network. The data platform 150 can facilitate the management of data produced, consumed, stored, or otherwise used or accessible by consumers of the data. Additionally, the data platform 150 may allow the network infrastructure controller to provide a microservice, data product, etc., to another network infrastructure controller, allow the network infrastructure controller to enforce data governance rules, perform audits, etc., of data produced by, stored on, used by, etc., other network infrastructure controllers, and perform other functions to manage the data platform as described herein.

In an example embodiment, the data platform 150 or computer-executable instructions stored on memory 402 of the network infrastructure component 400 are implemented using standard programming techniques. For example, the data platform 150 or computer executable instructions stored on memory 402 of the network infrastructure component 400 may be implemented as a “native” executable running on CPU 404, along with one or more static or dynamic libraries. In other embodiments, the data platform 150 or computer-executable instructions stored on memory 402 of the network infrastructure component 400 may be implemented as instructions processed by a virtual machine that executes as some other program.

The embodiments described above may also use synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented or performed by each component/module, and in different orders, and by different components/modules, yet still achieve the functions of the network infrastructure component 400.

In addition, programming interfaces to the data stored as part of the data platform 150 can be available by standard mechanisms such as through C, C++, C #, Java, and web APIs; libraries for accessing files, databases, or other data repositories; through scripting languages such as JavaScript and VBScript; or through Web servers, File Transfer Protocol (FTP) servers, or other types of servers providing access to stored data. The data platform 150 may be implemented by using one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions of the network infrastructure component 400 and network infrastructure components.

Furthermore, in some embodiments, some or all of the components/portions of the data platform 150, or functionality provided by the computer-executable instructions stored on memory 402 of the network infrastructure component 400 may be implemented or provided in other manners, such as at least partially in firmware or hardware, including, but not limited to, one or more application-specific integrated circuits (ASICs), standard integrated circuits, controllers (e.g., by executing appropriate instructions, and including microcontrollers or embedded controllers), field-programmable gate arrays (FPGAs), complex programmable logic devices (CPLDs), and the like. Some or all of the system components or data structures may also be stored as contents (e.g., as executable or other machine-readable software instructions or structured data) on a computer readable medium (e.g., as a hard disk; a memory; a computer network or cellular wireless network; or a portable media article to be read by an appropriate drive or via an appropriate connection, such as a DVD or flash memory device) so as to enable or configure non-transitory computer-readable medium or one or more associated computing systems or devices to execute or otherwise use or provide the contents to perform at least some of the described techniques. The non-transitory computer-readable storage medium includes instructions that when executed by a computing system, cause the computing system to perform operations described herein. Such computer program products may also take other forms in other embodiments. Accordingly, embodiments of this disclosure may be practiced with other computer system configurations.

In general, a range of programming languages may be employed for implementing any of the functionality of the servers, functions, user equipment, etc., present in the example embodiments, including representative implementations of various programming language paradigms and platforms, including but not limited to, object-oriented (e.g., Java, C++, C #, Visual Basic. NET, Smalltalk, and the like), functional (e.g., ML, Lisp, Scheme, and the like), procedural (e.g., C, Pascal, Ada, Modula, and the like), scripting (e.g., Perl, Ruby, PHP, Python, JavaScript, VBScript, and the like) and declarative (e.g., SQL, Prolog, and the like).

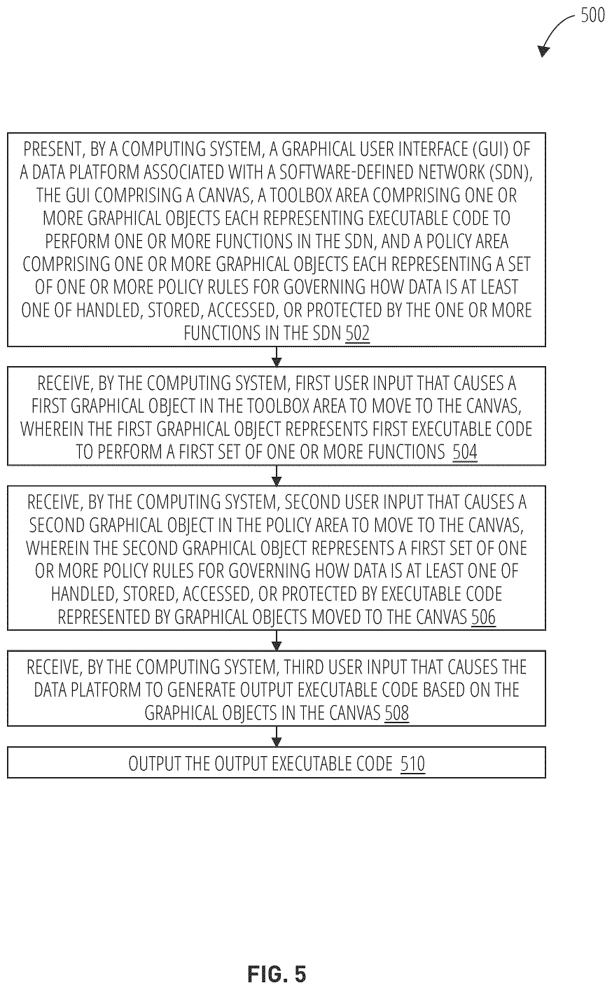

FIG. 5 is a flow chart of a method 500 of generating output executable code based on graphical objects in a canvas of a GUI presented by a data platform according to at least one embodiment. The method 500 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 500 is performed by the data platform 150 of FIG. 1 with the GUI 200 of FIG. 2. In one embodiment, the method 500 is performed by the network infrastructure component 400 of FIG. 4. The method 500 can be performed by other computing systems described herein.

Referring to FIG. 5, the method 500 begins with the processing logic presenting a GUI of a data platform associated with a SDN, the GUI comprising a canvas, a toolbox area including one or more graphical objects each representing executable code to perform one or more functions in the SDN, and a policy area comprising one or more graphical objects each representing a set of one or more policy rules for governing how data is at least one of handled, stored, accessed, or protected by the one or more functions in the SDN (block 502). At block 504, the processing logic receives first user input that causes a first graphical object in the toolbox area to move to the canvas, wherein the first graphical object represents first executable code to perform a first set of one or more functions. At block 506, the processing logic receives second user input that causes a second graphical object in the policy area to move to the canvas. The second graphical object represents a first set of one or more policy rules for governing how data is at least one of handled, stored, accessed, or protected by executable code represented by graphical objects moved to the canvas. At block 508, the processing logic receives third user input that causes the data platform to generate output executable code based on the graphical objects in the canvas. At block 510, the processing logic outputs the output executable code.

In a further embodiment, the first executable code is at least one of a utility program, an application, a function, a routine, a script, a processing pipeline, or a solution includes a plurality of interconnected blocks, each includes at least one of a utility program, an application, a function, a routine, a script, or a processing pipeline. In a further embodiment, the first set of one or more policy rules includes at least one of a data policy rule, a privacy policy rule, a quality policy rule, a retention policy rule, a security policy rule, a naming convention policy rule, a context data policy rule, or an access-model policy rule.

In a further embodiment, the method 500 may also include, prior to receiving the third user input: receiving fourth user input that causes a third graphical object in the toolbox area to move to the canvas, where the third graphical object represents second executable code to perform a second set of one or more functions, and receiving fifth user input that generates an interface between the first executable code of the first graphical object and the second executable code of the third graphical object, where the output executable code includes at least the first executable code, the second executable code, and the interface between the first executable code and the second executable code.

In a further embodiment, the first graphical object is a first solution includes a first plurality of interconnected blocks, each includes at least one of a utility program, an application, a function, a routine, a script, or a processing pipeline, and the second graphical object is a second solution includes a second plurality of interconnected blocks, each includes at least one of a utility program, an application, a function, a routine, a script, or a processing pipeline. In a further embodiment, the first graphical object is a first solution includes a first plurality of interconnected blocks, each includes at least one of a utility program, an application, a function, a routine, a script, or a processing pipeline, and the second graphical object is a processing pipeline.

In a further embodiment, the method 500 may also include receiving, by the computing system, fourth user input that modifies at least one of the first executable code of the first graphical object or the first set of one or more policy rules of the second graphical object, and receiving, by the computing system, fifth user input that creates a fourth graphical object in the toolbox area or the policy area, the fourth graphical object includes the at least one of the modified first executable code or the modified first set of one or more policy rules.

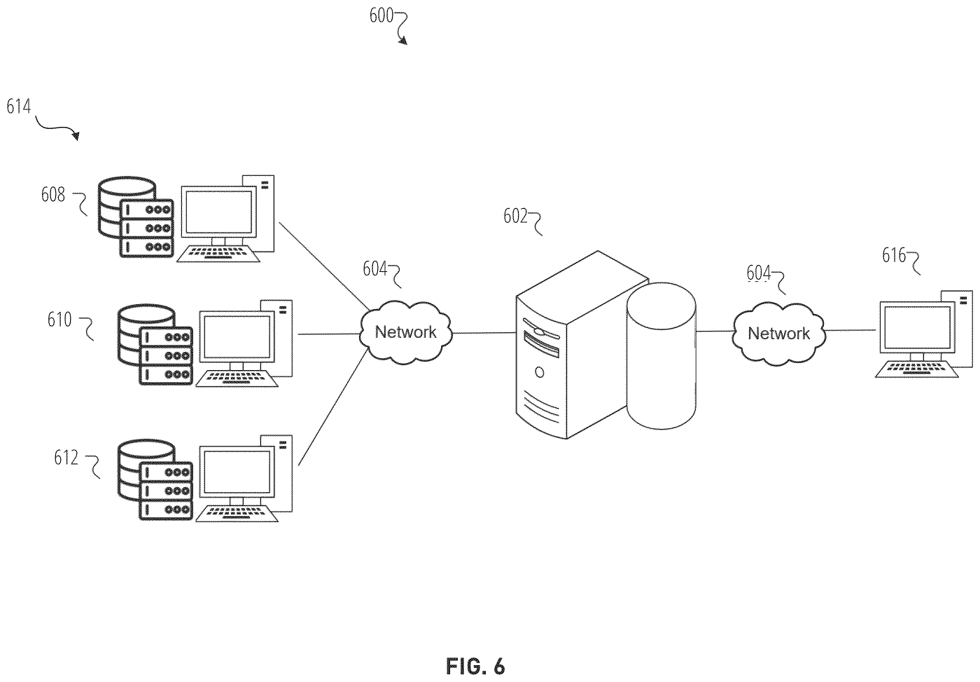

In a further embodiment, the method 500 can be performed by a computing system that is a cloud computing system. That is, the data platform can be implemented in the cloud computing system. The output executable code providing by the data platform 150 can be deployed in various locations of a cellular network (or other SDNs) for data collection, management, and storage, such as illustrated and described in the various examples of FIG. 6 to FIG. 9.

FIG. 6 is a block diagram of an example environment 600 for providing a data platform with a GUI for creating or modifying graphical objects representing underlying executable code for functions of a cellular network according to at least one embodiment. The example environment 600 includes a computing system 602 including one or more computing devices, a network 604, one or more data sources 614, and a user device 616.

The one or more data sources 614 can be located in different sites either on the same network or entirely different networks. Each data source 614 can have its own data included in data files. The data of each data sources 606 can include structured data, unstructured data, or both. Structured data refers to data that is organized in a specific format or structure, making it easy to search, process, and analyze using automated tools. This data is typically stored in databases, spreadsheets, or other data management systems. Structured data is characterized by the presence of clearly defined fields, columns, and rows, and often follows a consistent format or syntax. Examples of structured data include financial data, inventory data, customer information, and transactional data. Unstructured data refers to data that is not organized in a specific format or structure, making it difficult to process and analyze using automated tools. This data is often created in a free-form manner and does not follow a consistent syntax. For example, unstructured data is a conglomeration of many varied types of data that are stored in their native formats, which can result in irregularities and ambiguities that make it difficult to understand as compared to structured. Examples of unstructured data can include emails, social media posts, audio and video recordings, images, and text documents. Unstructured data is more difficult to analyze and interpret than structured data because it requires natural language processing and other advanced techniques to extract insights and meaning. However, unstructured data can provide valuable insights into customer sentiment, market trends, and other areas that are not easily captured by structured data.

Each data source 614 can have one or more data dictionaries describing its data files. The data dictionary can include information or metadata about data of the data files such as attributes, meaning, origin, usage, and format of the data included in the data files. For example, the metadata associated with the data files can include a plurality of features of the data included in the data files. The plurality of features can include at least one of: a file name, a table name, an attribute, a row name, and a column name. One of the features can be an attribute indicating whether a corresponding data file includes unstructured data.

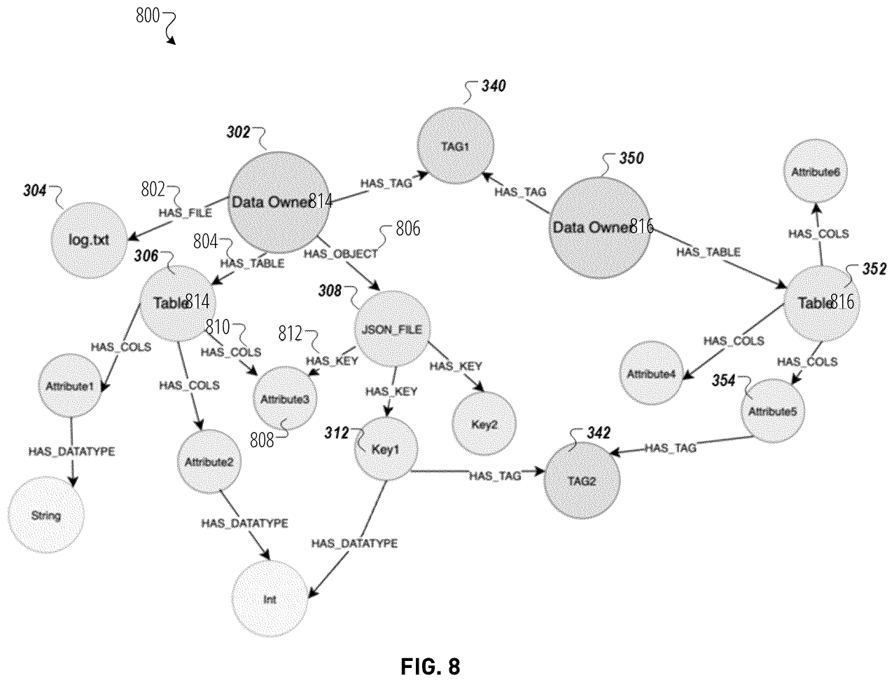

The data dictionaries of the data sources 614 can be used to create a graph database representing metadata of the data files from one or more data sources 614. Specifically, relationships among the plurality of features of different data files can be determined using the data files' data dictionaries. For example, a relationship can be two data files sharing the same attribute. A graph database can be created to reflect the features and the relationships of the features for different data files. The graph database can be represented as a directed graph that includes a set of nodes and a set of edges. Each node can represent a feature of the plurality of features. Each edge can represent a relationship between two nodes in the set of nodes (e.g., relationships among the plurality of features of the data files). As a result, the graph database can include the relationships (e.g., interconnections and interrelationships) of the data files from various data sources with respect to the features of the data files. An example graph database is described in FIG. 8.

In some implementations, the graph database can be generated by the computing system 602 in advance based on the data dictionaries received from the data sources 614. In some implementations, the graph database can be generated by another computing system (not shown). The computing system 602 can access the graph database from that computing system over the network.

The computing system 602 can traverse the graph database to identify unstructured data included in one or more data files from the data sources 614. The computing system 602 can further identify, from the graph database, the data sources 614 of data files that include unstructured data. For example, in a graph database, the data source 614 of each data file can be a represented as a node connected to another node representing the data file. In some implementations, the graph database can include a feature that indicates storage locations of particular data files. The computing system 602 can obtain the unstructured data, based on the storage location of the unstructured data, from the data source 614 and run assessment code on the computing system 602 to check the data quality of the unstructured data. In some implementations, the computing system 602 can provide the assessment code to the data source 614, so that the assessment code can be run at the data source 614.

The assessment code can check whether the unstructured data of the data files satisfies a set of rules. The set of rules can include customized rules that are specific to the use case of the unstructured data. For example, if the unstructured data is a log for user interactions with different applications, the customized rules can include rules to check whether the user's account includes a valid email address, but not whether the user provides a valid physical address. In another example, if the unstructured data includes online shopping orders, the customized rules include rules to check whether the shipping address is a valid physical address, and whether the shipping address is consistent with the postal code. In some implementations, the computing system can use machine learning models to determine the general rules and the customized rules for the unstructured data.

The computing system 602 can generate a data quality report for the unstructured data including i) the data quality results for the unstructured data in each data file and ii) recommendations of potential modifications for rectifying unstructured data not satisfying one or more rules included in the set of rules. The data quality report can be displayed on a user device 616. The user device 616 can be associated with a developer that utilizes the unstructured date and develops data products, artificial intelligence (AI)/machine learning (ML) algorithms, and dashboards. In some implementations, the data quality report can be provided to a user device 616 associated with a data owner of the unstructured data or an administrative user managing the unstructured data.

The computing system 602 can further provide the potential modifications to the unstructured data as a recommendation to the user device 616, so that the user of the user device 616 can determine whether to adopt that modification. In response to receiving the user's confirming to rectify the unstructured data not satisfying the one or more rules, the computing system 602 can proceed to make the modification. The computing system 602 can trigger rectifying code to make the modifications.

In some implementations, the computing system 602 can obtain the unstructured data, based on the storage location of the unstructured data, from the data source 614 and run the rectifying code on the computing system 602. In some implementations, the computing system 602 can provide the rectifying code to the data source 614, so that the rectifying code can be run at the data source 614.

The computing system 602 can include one or more computing devices, such as a server. The number of computing devices may be scaled (e.g., increased or decreased) automatically as per the computation resources needed. The various functional components of the computing system 602 may be installed on one or more computers as separate functional components or as different modules of a same functional component. For example, the various components of the computing system 602 can be implemented as computer programs installed on one or more computers in one or more locations that are coupled to each through a network. In cloud-based systems for example, these components can be implemented by individual computing nodes of a distributed computing system.

The user device 616 can include personal computer, mobile communication device, and other devices that can communicate with the computing system 602 over the network 604. The network 604 can include a local area network (“LAN”), wide area network (“WAN”), the Internet, or a combination thereof. Each data source 614 can include one or more computing devices, such as a server. Each data source 614 can have its own database that stores its data files and corresponding data dictionaries.

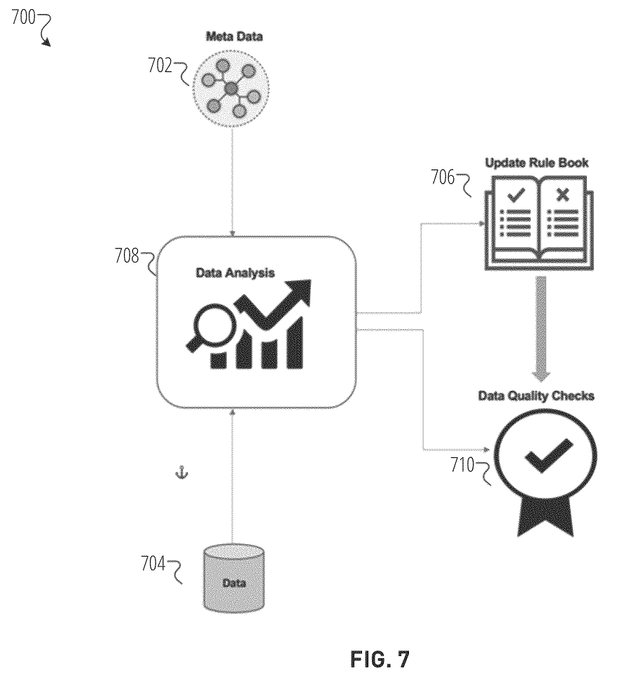

FIG. 7 is a block diagram of an example procedure 700 for assessing and improving the data quality of unstructured data in accordance with technology described herein. In some implementations, at least a portion of the procedure 700 can be executed at the computing system 602. In some implementations, at least a portion of the procedure 700 can be generated by the data platform 150 of FIG. 1, such as a result of manipulation of graphical objects in the canvas of the GUI 200 of FIG. 2.

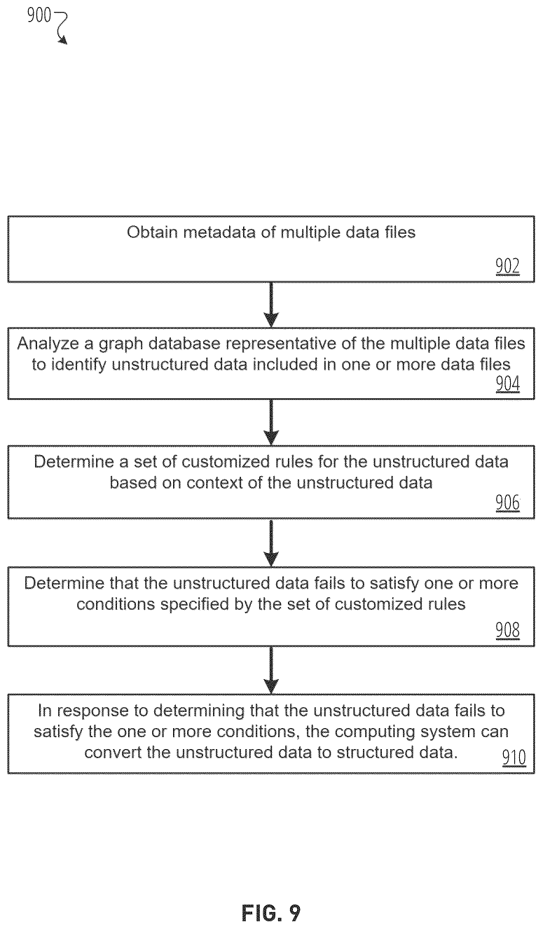

The computing system can traverse the graph database 702 representing the metadata of data files to identify unstructured data. The graph database 702 can include the storage location of the identified unstructured data. Based on the storage location, the computing system can obtain the unstructured data 704 from the corresponding data source. The computing system can determine a set of rules 706 for the unstructured data 704. The set of rules can include customized rules specific to the unstructured data. Based on the set of rules, the computing system can perform data analysis 708, such as data quality assessment, on the unstructured data to check whether the unstructured data 704 satisfies the set of rules 706. The computing system can generate a data quality report 710 including the results of the data quality assessment. FIG. 9 and associated descriptions provide additional details of these implementations.

FIG. 8 is an example of the graph database 800 representing metadata. The graph database 800 represent metadata of data files from two data sources/owners. The nodes in the graph database 800 include the plurality of features of the data files, including data sources/owners, data file names, attributes including keys, and tags. The edges in the graph database 800 represent the relationships between two nodes (e.g., relationships among the plurality of features of the data files from the two data sources).

For example, the relationships can be that the “Data Source 911” 302 has a data file named “log.txt” 304, has a table named “Table 1” 306, and has an object “JSON_FILE” 308. Such relationships are represented by edges 802, 307, and 309. In some implementations, the edges can be directed line with labels indicating the specific relationships. For example, the relationship of “Data Source 911” 302 having a data file named “log.txt” 304 can be represented by an edge 305 directed from the node “Data Source 911” 302 to the node “log.txt” 304. The label of the edge 305 can be “has file” to indicate the specific relationship.

In some examples, a relationship can be a data file including certain attributes or keys. For instance, the table named “Table 1” 306 can include “Attribute3” 310. The object data file named “JSON_FILE” 308 can include the same attribute “Attribute3” 310 as a key. Such relationships can be represented by the edge 810 directed from the node “Table 1” 306 to the node “Attribute3” 310 with label “has column” and by the edge 812 directed from the node “JSON_FILE” 308 to the node “Attribute3” 310 with label “has key.”

In some examples, a relationship can be two data files sharing the same attribute. Because the graph database includes the two edges 810 and 313 having a common node 808, the graph database indicates the relationship between the two data files “Table 1” 306 and “JSON_FILE” 308 that the two data files share the same attribute “Attribute3” 310.

In some examples, a relationship can be two data sources sharing the same tag. For example, “Data Source 911” 302 and “Data Source 913” 350 share the same tag “TAG 1” 340. In some examples, a relationship can be two attributes from data files of two separate data sources share the same tag. For example, the attribute “Key1” 312 of the data file “JSON_FILE” 308 from “Data Source 911” 302 and the attribute “Attribute5” 354 of the data file “Table 2” 352 from “Data Source 913” 350 share the same tag “TAG2” 342.

FIG. 9 is a flow diagram of an example process 900 for generating and using a graph database. In some implementations, at least a portion of the process 900 can be executed at the computing system 602. In some implementations, at least a portion of the method 500 can be generated by the data platform 150 of FIG. 1, such as a result of manipulation of graphical objects in the canvas of the GUI 200 of FIG. 2.

At block 902, the computing system can obtain metadata of multiple data files. The metadata can include data dictionaries of the data files. The data dictionary of a data file can include information or metadata about data of the data file, such as attributes, meaning, origin, usage, and format of the data included in the data files. One of the attributes can indicate whether a data file includes unstructured data.

The graph database can be generated using the metadata of data files, e.g., data dictionaries. Accordingly, the graph database can also include a feature indicating whether a data file includes unstructured data. Specifically, by analyzing the metadata of the multiple data files, relationships among the plurality of features of different data files can be determined. A graph database can be created to reflect the features and the relationships of the features for different data files. The graph database can be a directed graph that includes a set of nodes and a set of edges. Each node in the set of nodes can represent a feature of a plurality of features of the data files. For example, nodes included in the graph database can represent data file names, data sources, attributes, and tags. Each edge can represent a relationship between two nodes in the set of nodes (e.g., relationships among the plurality of features of the data files).

For example, edges included in the graph database can represent relationships among the data files, relationships between the data files and the data sources, relationships among the data sources, relationships among attributes of different data files, and relationships between the attributes and the data files. For example, the relationships can be that the “Data Source 912” has a data file named “log.txt”, has a table named “Table 1”, and has an object “JSON_FILE”. In some examples, a relationship can be a data file including certain attributes or keys. In some examples, a relationship can be two data files sharing the same attribute. In some examples, a relationship can be two data sources sharing the same tag.

At block 904, the computing system can analyze the graph database representative of the multiple data files to identify unstructured data included in one or more data files from the multiple data sources.

As discussed above, the graph database can include a feature for each data file indicating whether the data file includes unstructured data. The computing system can traverse or scan the graph database and identify data files that include unstructured data based on such a feature of the data files. Unstructured data is information that either does not have a pre-defined data model or is not organized in a pre-defined manner. Unstructured data is typically text-based but can contain non-textual data such as images, videos, etc. Unstructured data is usually stored in its native format, not in a structured database format, which can result in irregularities and ambiguities that make it difficult to understand as compared to data stored in fielded form in databases. Unstructured data can include images, text, JSON, comma-separated values (CSV), audio and video files, emails, social media posts, and the like. For example, the data file named “log.txt” include unstructured data.

The computing system can further identify, from the graph database, the data sources of the data files including unstructured data. For example, the data source of each data file can be a node connected to the node representing the data file. In some implementations, the data source can include a feature indicating a storage location of the data file.

At block 906, the computing system can determine a set of customized rules for the unstructured data based on context of the unstructured data. The set of customized rules can specify rules to be satisfied by the unstructured data, such as requirements and criteria that are specific to the use case or context of the unstructured data. For example, the set of customized rules can include rules to allow for the measurement of different data quality dimensions, such as contextual accuracy of values, consistency among values, allowed format of values, completeness of values, and the like.

For instance, when the unstructured data is a user interaction log across multiple applications, the customized rules can entail verifying the existence of a valid email address in the user's account.

The computing system can use metadata of the unstructured data to determine the context of the unstructured data of each data file. The computing system can analyze the metadata of the unstructured data using natural language processing to determine the context of the unstructured data. The metadata includes the data dictionary of the unstructured data. The computing system can determine the set of customized rules that are applicable to the unstructured data using the context of the unstructured data.

For example, the context for a data file including unstructured data indicates that the unstructured data includes a log for user interactions with different applications. For such context, the customized rules can include rules to check whether the user's account includes a valid email address, but not whether the user provides a valid physical address. In another example, the context of another data file including unstructured data indicate that the unstructured data includes online shopping orders. For such context, the customized rules include rules to check whether the shipping address is a valid physical address, and whether the shipping address is consistent with the postal code.

At block 908, the computing system can determine that the unstructured data fails to satisfy the set of customized rules. The computing system can perform data quality assessment on the unstructured data of the identified data files using the set of customized rules to obtain the data quality results. In some implementations, the computing system can trigger assessment code on the unstructured data to check the data quality. The assessment code can check whether the unstructured data of the data files satisfies the set of customized rules.

For example, to check whether the user's account includes a valid email address, a filter to search for email addresses in the log data can be created. This filter can be designed to extract email addresses that meet specific criteria, such as containing the “@” symbol and a top-level domain (e.g., “.com”, “.edu”, etc.). Similarly, other filters can be created to extract other relevant information, such as user IDs, session IDs, timestamps, and application names.

After the relevant data points are extracted, data quality of the unstructured data can be evaluated by validating the extracted data points against predefined criteria or performing additional analysis to identify patterns and anomalies. For example, the email addresses can be compared against a list of known valid addresses or statistical analysis can be performed to identify outliers and anomalies in the log data.

In some implementations, the data quality results include a data quality score for the unstructured data. The data quality score can be a combined quality score based on the data quality assessment for each rule included in the set of customized rules. In some implementations, the data quality results can include a quality score corresponding to each rule base on whether that rule is satisfied, and if not satisfied, on what level it is not satisfied.

By checking against the validation rules, it is possible to test whether the unstructured data meets the defined criteria and possesses the required attributes. In this way, the computing system can detect potential weak points in unstructured data and derive recommendations for action, such as recommendations for potential modifications to the unstructured data. For example, the computing system can detect unstructured data with a data quality score not satisfying a quality threshold or unstructured data not satisfying one or more rules.

In some implementations, the computing system can obtain the unstructured data, based on the storage location of the unstructured data, from the data source and run the assessment code on the computing system. In some implementations, the computing system can send the assessment code to the data source, so that the assessment code can be run at the data source.

In some implementations, the computing system can convert the unstructured data into structured data, which can be easily used by machine learning models, easily interpreted by users, and more accessible by tools. Converting unstructured data into structured data allows the computer system to utilize tools and models available for quality checks on structured data. To convert the unstructured data to structured data, the computing system can clean the unstructured data; extract the data entity, such as person, place, business, as well as their internal relationships; organize the data in a certain pattern based on the context and the relevant domain; and store the data in a structured format, such as in a relational database. The information included in the unstructured data should be preserved in the structured data. The computing system can assess the data quality of the unstructured data by assessing the structured data. Specifically, the computing system can assess the data quality of the unstructured data by converting the unstructured data into structured data and triggering an assessment code corresponding to the set of customized rules on the structured data to check whether the structured data satisfies the set of customized rules.

At block 910, in response to determining that the unstructured data fails to satisfy the set of customized rules, the computing system can modify the unstructured data to satisfy the set of customized rules.

In some implementations, the computing system can generate and output for display a data quality report for the unstructured data including i) the data quality results for the unstructured data in each data file and ii) recommendations of potential modifications for rectifying unstructured data not satisfying one or more rules included in the set of customized rules.

The data quality report can include the inconsistencies and the inaccuracies of the unstructured data, such as one or more rules included in the set of customized rules that are not satisfied by the unstructured data, and how the one or more rules are not satisfied. The data quality report can also include recommendations of potential modifications for addressing the unstructured data not satisfying the one or more rules.

In response to receiving a confirming to rectify the unstructured data not satisfying the one or more rules, the computing system can make modification to the unstructured data not satisfying the one or more rules according to the recommendations of potential modifications. The computing system can run rectifying code on the unstructured data to modify the unstructured data, so that the unstructured data can satisfy the one or more rules. For example, if the postal code of a physical address does not match the physical address, the computing system can determine the right postal code based on the physical address and replace the un-matching postal code with the right postal code.

In some implementations, the computing system can provide the potential modifications to the unstructured data as a recommendation to a user, so that the user can determine whether to adopt that modification. The user can be the owner of the unstructured data or an administrative user managing the unstructured data. In response to receiving a confirmation—e.g., from the user—to rectify the unstructured data, the computing system can proceed to make the modifications such that the unstructured data satisfies the set of customized rules.

In some implementations, the computing system can train a machine learning model for making recommendations of potential modifications based on historical low quality unstructured data (historical unstructured data not satisfying one or more rules) and the user's feedback on modifying the low-quality unstructured data. The computing system can run the machine learning model to determine the potential modifications for rectifying the unstructured data not satisfying one or more rules in the set of customized rules.

In some implementations, the computing system can obtain the unstructured data, based on the storage location of the unstructured data, from the data source and run the rectifying code on the computing system. In some implementations, the computing system can send the rectifying code to the data source, so that the rectifying code can be run at the data source.

In some implementations, the process 900 for generating data quality report of unstructured data and improving the data quality can be implemented using machine learning techniques.

The order of steps in the process 900 described above is illustrative only, and the process 900 can be performed in different orders. In some implementations, the process 900 can include additional steps, fewer steps, or some of the steps can be divided into multiple steps.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively or in addition, the carrier may be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed on a system of one or more computers in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices.

Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on one or more computers having, or configured to communicate with, a display device, e.g., a LCD (liquid crystal display) or organic light-emitting diode (OLED) monitor, a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on its software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially be claimed as such, one or more features from a claimed combination can in some cases be excised from the combination, and the claim may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
presenting, by a computing system, a graphical user interface (GUI) of a data platform associated with a software-defined network (SDN), the GUI comprising a canvas, a toolbox area comprising one or more graphical objects each representing executable code to perform one or more functions in the SDN, and a policy area comprising one or more graphical objects each representing a set of one or more policy rules for governing how data is at least one of handled, stored, accessed, or protected by the one or more functions in the SDN;
receiving, by the computing system, first user input that causes a first graphical object in the toolbox area to move to the canvas, wherein the first graphical object represents first executable code to perform a first set of one or more functions;
receiving, by the computing system, second user input that causes a second graphical object in the policy area to move to the canvas, wherein the second graphical object represents a first set of one or more policy rules for governing how data is at least one of handled, stored, accessed, or protected by executable code represented by graphical objects moved to the canvas;
receiving, by the computing system, third user input that causes the data platform to generate output executable code based on the graphical objects in the canvas; and
outputting the output executable code.

2. The method of claim 1, wherein the first executable code is at least one of a utility program, an application, a function, a routine, a script, a processing pipeline, or a solution comprising a plurality of interconnected blocks, each comprising at least one of a utility program, an application, a function, a routine, a script, or a processing pipeline.

3. The method of claim 1, wherein the first set of one or more policy rules comprises at least one of:
a data policy rule;
a privacy policy rule;
a quality policy rule;
a retention policy rule;
a security policy rule;
a naming convention policy rule;
a context data policy rule; or
an access-model policy rule.

4. The method of claim 1, further comprising, prior to receiving the third user input:
receiving fourth user input that causes a third graphical object in the toolbox area to move to the canvas, wherein the third graphical object represents second executable code to perform a second set of one or more functions; and
receiving fifth user input that generates an interface between the first executable code of the first graphical object and the second executable code of the third graphical object, wherein the output executable code comprises at least the first executable code, the second executable code, and the interface between the first executable code and the second executable code.

5. The method of claim 4, wherein:
the first graphical object is a first solution comprising a first plurality of interconnected blocks, each comprising at least one of a utility program, an application, a function, a routine, a script, or a processing pipeline; and
the second graphical object is a second solution comprising a second plurality of interconnected blocks, each comprising at least one of a utility program, an application, a function, a routine, a script, or a processing pipeline.

6. The method of claim 4, wherein:
the first graphical object is a first solution comprising a first plurality of interconnected blocks, each comprising at least one of a utility program, an application, a function, a routine, a script, or a processing pipeline; and
the second graphical object is a processing pipeline.

7. The method of claim 1, further comprising:
receiving, by the computing system, fourth user input that modifies at least one of the first executable code of the first graphical object or the first set of one or more policy rules of the second graphical object; and
receiving, by the computing system, fifth user input that creates a fourth graphical object in the toolbox area or the policy area, the fourth graphical object comprising the at least one of the modified first executable code or the modified first set of one or more policy rules.

8. The method of claim 1, wherein the computing system is a cloud computing system, and wherein the data platform is implemented in the cloud computing system.

9. A non-transitory computer-readable storage medium, the computer-readable storage medium including instructions that when executed by a computing system, cause the computing system to perform operations comprising:
presenting a graphical user interface (GUI) of a data platform associated with a software-defined network (SDN), the GUI comprising a canvas, a toolbox area comprising one or more graphical objects each representing executable code to perform one or more functions in the SDN, and a policy area comprising one or more graphical objects each representing a set of one or more policy rules for governing how data is at least one of handled, stored, accessed, or protected by the one or more functions in the SDN;
receiving first user input that causes a first graphical object in the toolbox area to move to the canvas, wherein the first graphical object represents first executable code to perform a first set of one or more functions;
receiving second user input that causes a second graphical object in the policy area to move to the canvas, wherein the second graphical object represents a first set of one or more policy rules for governing how data is at least one of handled, stored, accessed, or protected by executable code represented by graphical objects moved to the canvas;
receiving third user input that causes the data platform to generate output executable code based on the graphical objects in the canvas; and
outputting the output executable code.

10. The non-transitory computer-readable storage medium of claim 9, wherein the first executable code is at least one of a utility program, an application, a function, a routine, a script, a processing pipeline, or a solution comprising a plurality of interconnected blocks, each comprising at least one of a utility program, an application, a function, a routine, a script, or a processing pipeline.

11. The non-transitory computer-readable storage medium of claim 9, wherein the first set of one or more policy rules comprises at least one of:
a data access policy rule;
a privacy policy rule;
a quality policy rule;
a retention policy rule;
a security policy rule;
a naming convention policy rule;
a context data policy rule; or
an access-model policy rule.

12. The non-transitory computer-readable storage medium of claim 9, wherein the operations further comprise:
prior to receiving the third user input:
receiving fourth user input that causes a third graphical object in the toolbox area to move to the canvas, wherein the third graphical object represents second executable code to perform a second set of one or more functions; and
receiving fifth user input that generates an interface between the first executable code of the first graphical object and the second executable code of the third graphical object, wherein the output executable code comprises at least the first executable code, the second executable code, and the interface between the first executable code and the second executable code.

13. The non-transitory computer-readable storage medium of claim 12, wherein:
the first graphical object is a first solution comprising a first plurality of interconnected blocks, each comprising at least one of a utility program, an application, a function, a routine, a script, or a processing pipeline; and
the second graphical object is a second solution comprising a second plurality of interconnected blocks, each comprising at least one of a utility program, an application, a function, a routine, a script, or a processing pipeline.

14. The non-transitory computer-readable storage medium of claim 12, wherein:
the first graphical object is a first solution comprising a first plurality of interconnected blocks, each comprising at least one of a utility program, an application, a function, a routine, a script, or a processing pipeline; and
the second graphical object is a processing pipeline.

15. The non-transitory computer-readable storage medium of claim 9, wherein the operations further comprise:
receiving, by the computing system, fourth user input that modifies at least one of the first executable code of the first graphical object or the first set of one or more policy rules of the second graphical object; and
receiving, by the computing system, fifth user input that creates a fourth graphical object in the toolbox area or the policy area, the fourth graphical object comprising the at least one of the modified first executable code or the modified first set of one or more policy rules.

16. A computing system comprising:
a processor; and
a memory storing instructions that, when executed by the processor, configure the computing system to:
present a graphical user interface (GUI) of a data platform associated with a software-defined network (SDN), the GUI comprising a canvas, a toolbox area comprising one or more graphical objects each representing executable code to perform one or more functions in the SDN, and a policy area comprising one or more graphical objects each representing a set of one or more policy rules for governing how data is at least one of handled, stored, accessed, or protected by the one or more functions in the SDN;
receive first user input that causes a first graphical object in the toolbox area to move to the canvas, wherein the first graphical object represents first executable code to perform a first set of one or more functions;
receive second user input that causes a second graphical object in the policy area to move to the canvas, wherein the second graphical object represents a first set of one or more policy rules for governing how data is at least one of handled, stored, accessed, or protected by executable code represented by graphical objects moved to the canvas;
receive third user input that causes the data platform to generate output executable code based on the graphical objects in the canvas; and
output the output executable code.

17. The computing system of claim 16, wherein the first executable code is at least one of a utility program, an application, a function, a routine, a script, a processing pipeline, or a solution comprising a plurality of interconnected blocks, each comprising at least one of a utility program, an application, a function, a routine, a script, or a processing pipeline.

18. The computing system of claim 16, wherein the first set of one or more policy rules comprises at least one of:
a data access policy rule;
a privacy policy rule;
a quality policy rule;
a retention policy rule;
a security policy rule;
a naming convention policy rule;
a context data policy rule; or
an access-model policy rule.

19. The computing system of claim 16, wherein the computing system is further to, prior to receiving the third user input:
receiving fourth user input that causes a third graphical object in the toolbox area to move to the canvas, wherein the third graphical object represents second executable code to perform a second set of one or more functions; and
receiving fifth user input that generates an interface between the first executable code of the first graphical object and the second executable code of the third graphical object, wherein the output executable code comprises at least the first executable code, the second executable code, and the interface between the first executable code and the second executable code.

20. The computing system of claim 19, wherein the computing system is a cloud computing system, and wherein the data platform is implemented in the cloud computing system.
